(19) United States
(12) Patent Application Publication
(10) Pub. No.: US 2013/0054553 A1
(43) Pub. Date: Feb. 28, 2013

(54) METHOD AND APPARATUS FOR AUTOMATICALLY EXTRACTING INFORMATION OF PRODUCTS

(71) Applicants: Yeo Chan YOON, Daejeon (KR); HyunKi Kim, Daejeon (KR); Hyo-Jung Oh, Daejeon (KR); Changki Lee, Daejeon (KR); Chung Hee Lee, Daejoen (KR); Myung Gil Jang, Daejeon (KR); Yohan Jo, Daejeon (KR); Miran Choi, Daejeon (KR); Yoonjae Choi, Daejeon (KR); Jeong Heo, Daejeon (KR); Pum Mo Ryu, Daejeon (KR); Hyeon Jin Kim, Daejeon (KR)

(72) Inventors: Yeo Chan YOON, Daejeon (KR); HyunKi Kim, Daejeon (KR); Hyo-Jung Oh, Daejeon (KR); Changki Lee, Daejeon (KR); Chung Hee Lee, Daejoen (KR); Myung Gil Jang, Daejeon (KR); Yohan Jo, Daejeon (KR); Miran Choi, Daejeon (KR); Yoonjae Choi, Daejeon (KR); Jeong Heo, Daejeon (KR); Pum Mo Ryu, Daejeon (KR); Hyeon Jin Kim, Daejeon (KR)

(73) Assignee: ELECTRONICS AND TELECOMMUNICATIONS RESEARCH INSTITUTE, Daejeon (KR)

(21) Appl. No.: 13/559,029

(22) Filed: Jul. 26, 2012

(30) Foreign Application Priority Data
Aug. 24, 2011 (KR) 10-2011-0084529

(51) Int. Cl. G06F 17/30

(52) U.S. Cl. 707/706; 707/737; 707/E17.089; 707/E17.108

(57) ABSTRACT

A method for automatically extracting information of products, includes searching documents based on product names; and extracting sentences including advantages and disadvantages for products having the product names from the searched documents. Further, the method for automatically extracting the information of the products includes classifying the sentences by similar contents among the extracted sentences; selecting representative sentences among the classified sentences; and calculating each weight of the selected representative sentences.

### CROSS-REFERENCE TO RELATED APPLICATIONS

The present invention claims priority of Korean Patent Application No. 10-2011-0084529, filed on Aug. 24, 2011 which is incorporated herein by reference.

### FIELD OF THE INVENTION

The present invention relates to a technology for automatically extracting information of products; and more particularly, to a method and an apparatus for automatically extracting information of products, which are capable of automatically extracting advantages and disadvantages of specific products posted on web documents and fixing the advantages and disadvantages and providing the fixed advantages and disadvantages to users.

### BACKGROUND OF THE INVENTION

Examples of the related art for extracting information of specific products on web documents may include a wrapper technology of extracting information that is formed in a table type, a relation extraction technology of analyzing and extracting sentences of non-descriptive information such as product manufacturer, specification, and the like, and a sentiment analysis technology of extracting positive and negative opinions on specific entities such as products, enterprises, and the like.

The wrapper technology, which is a scheme of extracting information that is described in the web documents as the table type as shown in FIG. 2, mainly represents objective and general information such as specification for products, and the like. The wrapper technology may extract information only when the information is described in the table type and as a result, may not easily extract information that is described in a description type rather than the table type like the advantage and disadvantage information.

The relation extraction technology is a technology of extracting information, which is described in documents as a sentence type, into a triple type. The triple type refers to as a subject-property-value (object) type. For example, when a sentence like “manufacturer of Galaxy S is SamSung” is provided, the sentence may be represented as ‘Galaxy S-Manufacturer-Samsung’. Further, the relation extraction technology is to extract the objective and general information like the wrapper technology. In addition, since a portion corresponding to the value (object) in the triple structure is mainly filled with a non-descriptive value such as factoid, the relation extraction technology may not extract the descriptive information and may not easily applied to the extraction of the advantages and disadvantages of products.

The sentiment analysis technology is a technology of detecting the positive or negative opinions on the specific entities and monitoring the detected positive and negative opinions on the corresponding entities. The technology of recognizing opinions on sentiment representations, e.g., “good”, “bad”, “fresh”, “criticized,” and the like, for entities mainly recognizes the corresponding representations and therefore, intimacy and non-intimacy for the specific entities may be measured.

The sentiment analysis technology recognizes opinions only in the viewpoint of the intimacy and the non-intimacy and may not recognize objective features that represent more detailed information and opinions on the specific products. For example, the sentiment analysis technology may not recognize sentences describing advantages (objective features) such as ‘screen is wide’, and the like and may not classify and present the main advantages and disadvantages for the specific products. Accordingly, the users may obtain only the limited information such as the intimacy and the non-intimacy.

In the method for extracting information of specific products in the web documents in accordance with the related art as described above, only the objective information of the table type is extracted, the descriptive information is not extracted, and only the intimacy is measured. Therefore, the sentences and the advantages and disadvantages that represent the technical features for the specific products may not be analyzed or presented.

### SUMMARY OF THE INVENTION

In view of the above, the present invention provides a method and an apparatus for automatically extracting information of products, which is capable of automatically extracting advantages and disadvantages for specific products posted on web documents and arranging the advantages and disadvantages and providing the arranged advantages and disadvantages to users.

Further, the present invention provides a method and an apparatus for automatically extracting information of products, which are capable of querying target products to search the related documents, extracting sentences which mention advantages and disadvantages of products in the searched documents, classifying advantages and disadvantages by similar contents, selecting representative sentences to be provided to users, assigning weight to each of the classified advantages and disadvantages based on the number of sentences included in each classification, and providing the assigned weighted value to the users.

In accordance with a first aspect of the present invention, there is provided a method for automatically extracting information of products, including: searching documents based on product names; extracting sentences including advantages and disadvantages for products having the product names from the searched documents; classifying the sentences by similar contents among the extracted sentences; selecting representative sentences among the classified sentences; and calculating each weight of the selected representative sentences.

In accordance with a second aspect of the present invention, there is provided a method for automatically extracting information of products, including: collecting electronic documents including information of specific products; extracting sentences including advantages and disadvantages for product names of the specific products from the collected electronic documents through language analysis; classifying sentences having similar contents among the extracted sentences; selecting representative sentences among the classified sentences; calculating each weight for the selected representative sentences; and performing and outputting modeling of analysis information based on the extracted sentences, the selected representative sentences, and the calculated weight information.

In accordance with a third aspect of the present invention, there is provided an apparatus for auto extracting information of products, including: a search engine unit configured to collect electronic documents included in information for specific products; a advantage and disadvantage sentence extractor configured to extract sentences including advantages and disadvantages for products for product names from the collected electronic documents; a similar meaning advantages and disadvantage classifier configured to perform a sort between sentences having similar meanings based on whether predetermined pattern information or vocabularies among the extracted sentences are posted; a representative advantages and disadvantage labeling unit configured to select representative sentences based on the whether a length of sorted sentences and preset representative words are included; and a weight calculator configured to calculate weights based on how frequently the advantages and disadvantages included in the selected representative sentences are generated.

In accordance with an embodiment of the present invention, it is possible to automatically extract the advantages and disadvantages of products posted on the wed documents, classify the extracted advantages and disadvantages of the products by similar contents and provide the classified advantages and disadvantages of the products to the users.

Accordingly, the users can refer to the provided advantages and disadvantages of the products when monitoring and purchasing the products, and a manufacturer of the products can use the results of the system as a feedback of the users for the corresponding products.

### BRIEF DESCRIPTION OF THE DRAWINGS

The objects and features of the present invention will become apparent from the following description of embodiments given in conjunction with the accompanying drawings, in which:

FIG. 1 is a block diagram of an apparatus for automatically extracting information of products in accordance with an embodiment of the present invention:

FIG. 2 is a diagram illustrating structured information of products posted on web documents in a conventional table type;

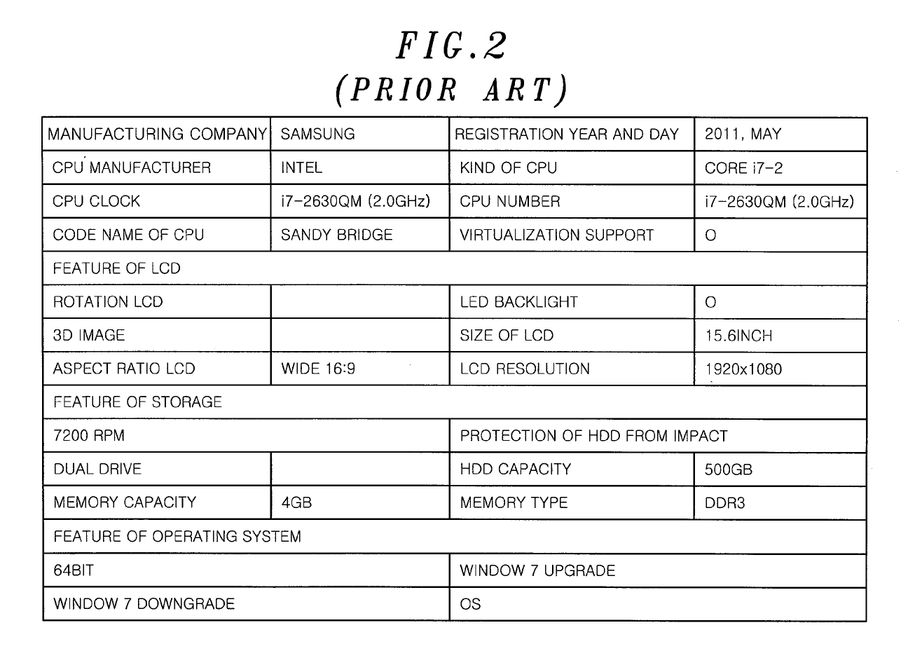

FIG. 3 is a diagram illustrating users' opinions on specific products;

FIG. 4 is a diagram illustrating a method for extracting sentences describing advantages of specific products on web documents in accordance with the embodiment of the present invention;

FIG. 5 is a diagram illustrating sentences classifying advantages of specific products by similar meanings in accordance with the embodiment of the present invention;

FIG. 6 is a block diagram illustrating output results of the apparatus for automatically extracting information of products, which is shown in FIG. 1; and

FIG. 7 is a block diagram illustrating an operation procedure of the apparatus for automatically extracting information of products shown in FIG. 1.

### DETAILED DESCRIPTION OF THE EMBODIMENTS

Embodiments of the present invention will be described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram.

Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective sequences of the sequence diagram.

Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

Hereinafter, embodiments of the present invention will be described in detail with reference to the accompanying drawings which form a part hereof.

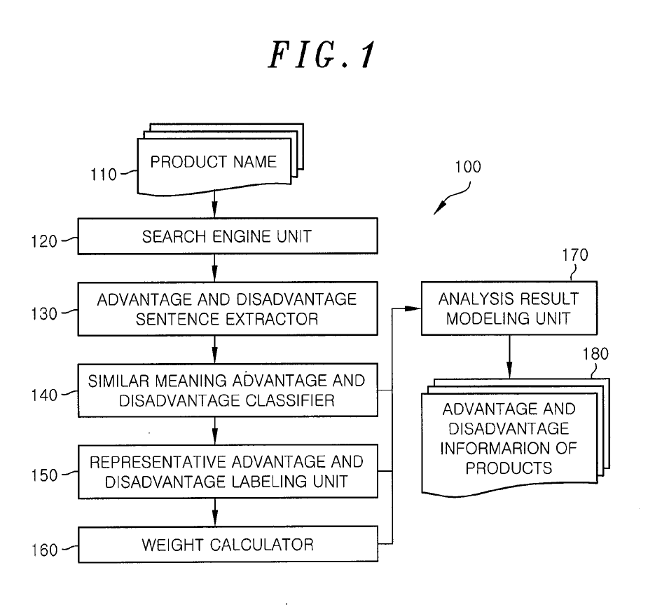

FIG. 1 is a block diagram illustrating an apparatus for automatically extracting information of products in accordance with an embodiment of the present invention.

Referring to FIG. 1, an apparatus 100 for automatically extracting information of products t may receive product names 110 of which the advantages and disadvantages are to be understood and provide the advantage and disadvantage information of the corresponding products. The apparatus 100 for automatically extracting the information of the products includes a search engine unit 120, an advantage and disadvantage sentence extractor 130, a similar meaning advantage and disadvantage classifier 140, a representative advantage and disadvantage labeling unit 150, a weight calculator 160, and an analysis result modeling unit 170.

The apparatus 100 for automatically extracting information of the products is connected to an Internet network to be interlocked with a plurality of web sites or is built in one of the web site severs to provide the information of the products based on information of the web document within the web site.

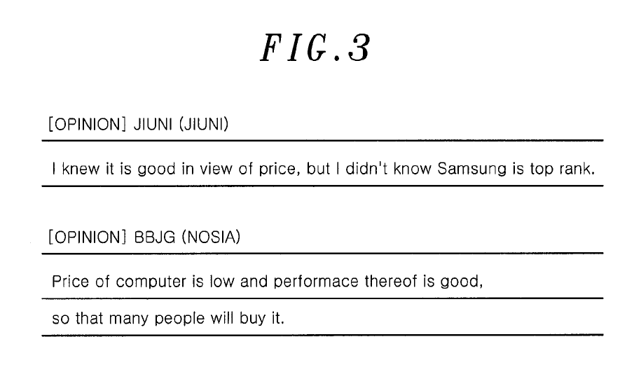

The search engine unit 120 may search information of the products on at least one web site to extract related documents and search the information thereof by using the product names 110 as a query on the web documents. For example, in order for the users to understand usefulness of the products when purchasing specific products through sites that sell various products, they frequently search comments for the products written by other users through the web documents. The comments for the products are generally documents in which advantages and disadvantages are written by the users that have been purchased and used the products, as illustrated in FIG. 3.

In this case, the query for extracting the advantage and disadvantage information may be configured by “product name”+“disadvantages”, and “product name”+“advantages”. In addition, brand names may be searched together to perform an accurate search.

For example, the information is searched by using two queries of “PAVV LN40XXXX advantage” and “PAVV LN40XXXX disadvantage” for a product called LN40XXXX of brand name PAVV of Samsung. Further, the search engine unit 120 may recognize unspecified product names by using the language analysis technology such as entity name recognition, and the like, in the previously collected documents based on the product names to find out the documents on which the recognized product names appear, rather than the method for searching the web documents.

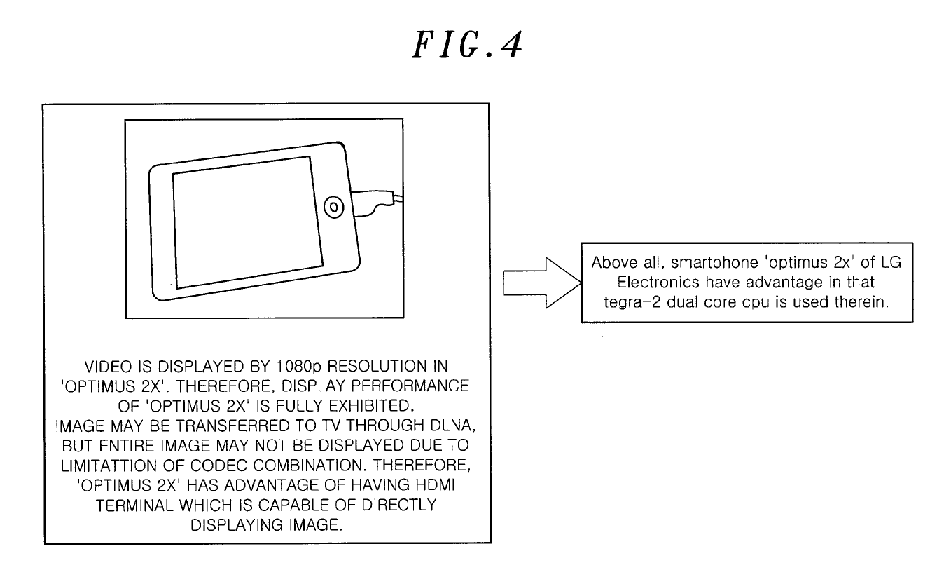

The advantage and disadvantage sentence extractor 130 may extract sentences in which the advantages and disadvantages are described, based on the documents searched by the search engine unit 120. FIG. 4 illustrates an example of extracting sentences describing advantages in the searched documents.

As the method for extracting the sentences, there are a pattern based method, a method for analyzing main appearance words, a method of mixing the former two methods and the like. The pattern based method is a method for manually setting patterns such as ‘advantages of [product name]’ to extract sentences matching the manually set patterns. The method for analyzing main appearance words is a method for analyzing what words frequently appear in the sentences describing the advantages or the disadvantages and extracting the sentences in which the words frequently appear as the advantage or disadvantage sentences. For example, words such as “advantages”, “good”, “excellent”, and the like, frequently appear in the sentences describing advantages, while words such as “disadvantages”, “bad”, and the like, frequently appear in the sentences describing the disadvantages”.

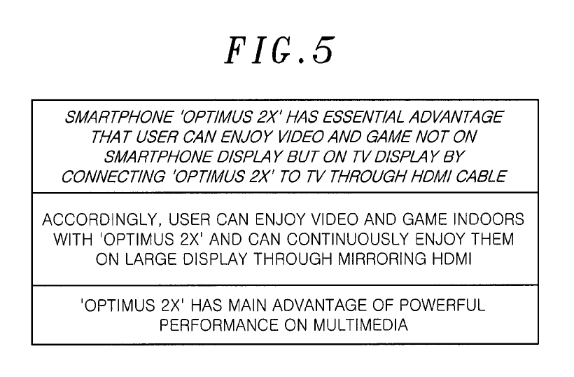

The similar meaning advantages and disadvantages classifier 140 may classify the sentences that represent the similar advantages and disadvantages. FIG. 5 is an example of classifying sentences describing the same advantages among the extracted sentences. Therefore, the users can differentiate the sentences representing the same advantages from other advantages and disadvantages to understand same. In order to classify the same advantages, whether to share at least one main vocabulary appearing in the sentences is determined. As a result, if it is determined that the main vocabularies are shared between respective sentences, the sentences are classified to have the similar meanings.

As shown in FIG. 5, since words such as HDMI, TV, video, games, and the like, are shared in the sentences as main vocabularies, the sentences may each be classified by the similar meanings.

The representative advantage and disadvantage labeling unit 150 may select the representative sentences among the sentences classified by the similar meaning advantage and disadvantage classifier 140. The representative sentences may be selected in consideration of whether a length of the sentence and preset representative words are included. The preset representative words do not appear in general documents well, but may be referred to as words frequently appearing in the classified sentences. FIG. 5 illustrates a case in which a first sentence is selected as representative sentence, and the representative words include hdmi, tv, and the like. The users may understand the advantages and disadvantages of the products at a time by seeing only the representative sentence.

In order to analyze what advantages and disadvantages are considered to be important for each advantage and disadvantage classification, the weight calculator 160 calculates weights and assigns higher weights to advantages and disadvantages provided by a large number of users among the extracted advantages and disadvantages, while assigns lower weights to advantages and disadvantages provided by a small number of users. Accordingly, the users may refer to the assigned weights. The weights may be calculated by considering the number of sentences included in each classification, quality of the sentences, and the like.

The weight calculator 160 may calculate the weights of the classification based on the number of sentences included in each classification and may not represent the calculated weights but represent the weights by the number of sentences for each classification, i.e., the number of opinions or a recommended number after receiving a consent from the users confirming the calculated weights.

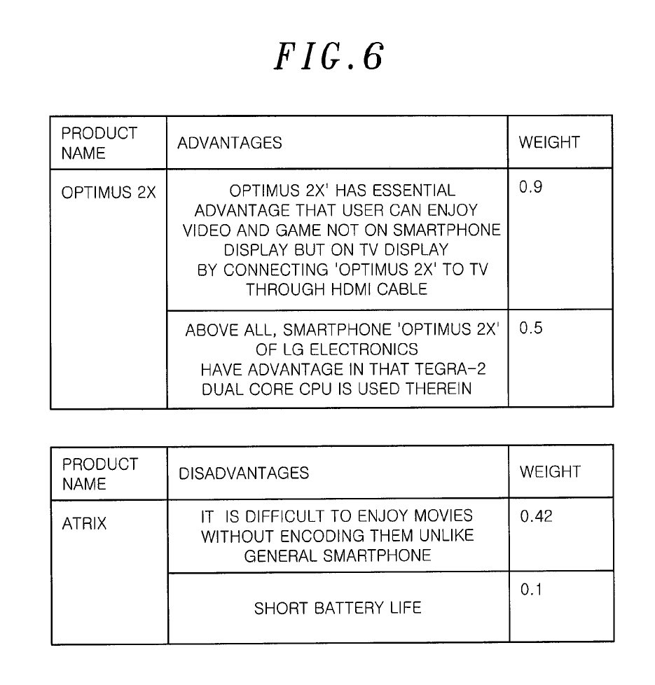

The analysis result modeling unit 170 may perform modeling for providing finally analyzed advantage and disadvantage information to the users and receives information from the similar meaning advantage and disadvantage classifier 140, the representative advantage and disadvantage labeling unit 150, and the weight calculator 160, respectively and may provide the advantages and disadvantages analyzed for the products to the users based thereon. As shown in FIG. 6, the advantages and disadvantages of the specific products are extracted from the web documents and sentences of similar contents are classified into one and the weight is assigned to each of the sentences such that the users can understand weight of each advantage and disadvantage. The higher weight may be assigned to the advantage and disadvantage that are mentioned by a large number of users, while the lower weight may be assigned to the advantage and disadvantage that are mentioned by a small number of users.

The users may review the assigned weights to determine how reliable the extracted advantages and disadvantages are.

Herein, the modeling is performed to represent the advantages and disadvantages in a web service type, a document file type including a table, and the like. For example, when the representative labeling is clicked in the web service type, the sentences included in the corresponding classification and the additional information (e.g., written date, original text, URL source of the original text) related to the sentences can be provided together.

As described above, in accordance with the embodiment of the present invention, the modeling is performed to extract information of the specific products. However, unlike the related art, the advantage and disadvantage information that is described in a description type is extracted, the similar information among the extracted information is classified and what advantages and disadvantages the users are frequently provided is determined, which helps the users purchase or monitor products. That is, in a portion corresponding to the value (object) in the triple structure, the description type, e.g., descriptive information such as “battery life is long’ rather than a factoid type may be extracted, unlike the related art. In addition, the extracted information is classified and the weights are assigned to the classified information to determine what information has larger weights and then, the assigned weights are provided to the users.

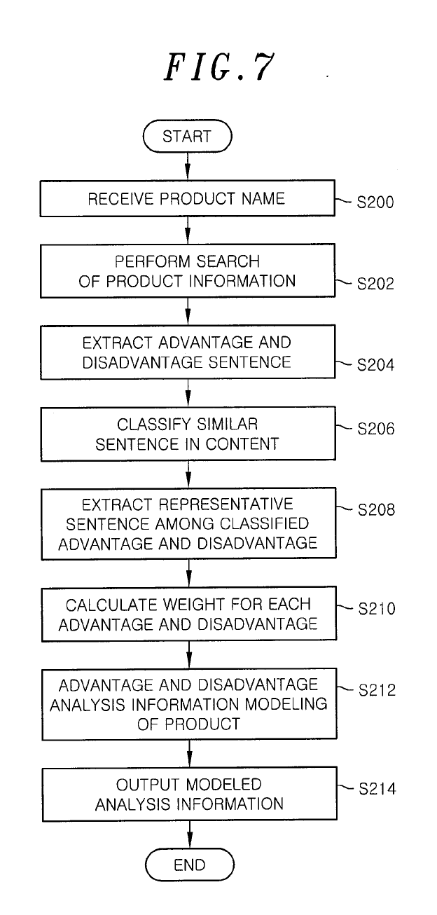

FIG. 7 is a flow chart illustrating an operation procedure of the apparatus for automatically extracting information of products in accordance with an embodiment of the present invention.

Referring to FIG. 7, in step S200, the apparatus 100 for automatically extracting information of products receives the product names 110 posted on sites selling specific products and transfers the received product names 110 to the search engine unit 120. The search engine unit 120 searches the information on the product names 110 transferred in step S202 and transfers the searched information to the advantage and disadvantage sentence extractor 130.

In step S204, the advantage and disadvantage sentence extractor 130 uses the searched information to extract the sentences describing the advantages and disadvantages of the products. The extracted sentence is transferred to the similar meaning classifier 140 and the similar meaning classifier 140 classifies the extracted sentence by the similar sentences in step S206.

Next, the classified advantage and disadvantage information is transferred to the representative advantage and disadvantages labeling unit 150 and in step S208, the representative advantage and disadvantage labeling unit 150 selects the representative sentences based on whether the preset length or the representative words are included.

In step S210, the weight calculator 160 receives the representative sentences selected by the representative labeling unit 150 and calculates the weights. The analysis result modeling unit 170 receives the information t from the similar meaning advantage and disadvantage classifier 140, the representative advantage and disadvantage labeling unit 150, and the weight calculator 160, respectively, and models the advantage and disadvantage analysis information of the products in a preset type (e.g., web service, document file type, and the like) in step S212 and outputs the modeled analysis information in step S214 as the final results.

As described above, in accordance with the embodiment of the present invention, the advantage and disadvantage described in a description type in the electronic documents such as the web pages or the web documents are extracted and the extracted advantages and disadvantages of the similar contents are classified and the classified advantages and disadvantages are provided to the users, thereby easily understanding the advantages and disadvantages of the specific products.

That is, a method for extracting sentences of advantages and disadvantages for the products by using a language analysis technology, a pattern information technology, and vocabulary frequency information, thereby solving problems in that the related art cannot extract descriptive information. In addition, the related art simply illustrates positive and negative information about entities or performs digitization or statistics treatment on the information, while the embodiment of the present invention classifies the extracted advantages and disadvantages and provides the extracted advantages and disadvantages to the users and assigns the weights to the classified advantages and disadvantages to digitize information about what advantages and disadvantages the users are well known and provide the digitized information to the users, so that the users can more specifically obtain the information of products.

However, the embodiment of the present invention has been described the method for automatically extracting information of products based on the analysis of the web documents that are provided to the users within the web sites, but is not limited to the web documents and may be implemented by being applied to various fields that are required to analyzes the information of products written on various electronic documents and monitor the product, and the like.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A method for automatically extracting information of products, comprising:
searching documents based on product names;
extracting sentences including advantages and disadvantages for products having the product names from the searched documents;
classifying the sentences by similar contents among the extracted sentences;
selecting representative sentences among the classified sentences; and
calculating each weight of the selected representative sentences.

2. The method of claim 1, wherein said searching documents is performed based on a query that is configured by the product names and the advantages and the product names and the disadvantages, respectively.

3. The method of claim 1, wherein said extracting sentences, the sentences describing the advantages and disadvantages are extracted from the documents searched by the product names by using specific pattern information.

4. The method of claim 1, wherein said extracting sentences is performed such that the sentences describing the advantages and disadvantages are extracted based on whether preset vocabularies are posted in the documents searched by the product names.

5. The method of claim 1, wherein said classifying the sentences is performed such that it is determined whether there are shared vocabularies for each sentence and if it is determined that the shared vocabularies are present in each sentence, each sentence is classified as similar content.

6. The method of claim 1, wherein said selecting representative sentences is performed such that the representative sentences are selected by determining whether a length of the sorted sentences and preset representative words are included.

7. The method of claim 1, wherein said calculating each weight is performed such that the number of sentences is set as a reference of weight and preset higher weights are assigned to the advantages posted exceeding the reference of the weight and preset lower weights are assigned to the advantages posted below the reference of the weight.

8. The method of claim 1, further comprising:
performing and outputting modeling of analysis information based on the extracted sentences, the selected representative sentences, and calculated weight information.

9. The method of claim 8, wherein said performing and outputting modeling of analysis information is a web service type providing sentences included in the representative sentences and additional information related to the sentences.

10. A method for automatically extracting information of products, comprising:
collecting electronic documents including information of specific products;
extracting sentences including advantages and disadvantages for product names of the specific products from the collected electronic documents through language analysis;
classifying sentences having similar contents among the extracted sentences;
selecting representative sentences among the classified sentences;
calculating each weight for the selected representative sentences; and
performing and outputting modeling of analysis information based on the extracted sentences, the selected representative sentences, and the calculated weight information.

11. An apparatus for auto extracting information of products, comprising:
a search engine unit configured to collect electronic documents included in information for specific products;
a advantage and disadvantage sentence extractor configured to extract sentences including advantages and disadvantages for products for product names from the collected electronic documents;
a similar meaning advantages and disadvantage classifier configured to perform a sort between sentences having similar meanings based on whether predetermined pattern information or vocabularies among the extracted sentences are posted;
a representative advantages and disadvantage labeling unit configured to select representative sentences based on the whether a length of sorted sentences and preset representative words are included; and
a weight calculator configured to calculate weights based on how frequently the advantages and disadvantages included in the selected representative sentences are generated.

12. The apparatus of claim 11, wherein the search engine unit performs the search based on a query that is configured by the product names and the advantages and the product names and the disadvantages.

13. The apparatus of claim 11, wherein the advantage and disadvantage sentence extractor extracts the sentences describing the advantages and disadvantages from the documents searched as the product names by using predetermined pattern information

14. The apparatus of claim 11, wherein the advantage and disadvantage sentence extractor extracts the sentences describing the advantages and disadvantages based on whether preset vocabularies are posted in the documents searched as the product names.

15. The apparatus of claim 11, wherein the similar meaning classifier determines whether there are shared vocabularies for each sentence and if it is determined that the shared vocabularies are present in each sentence, classifies each sentence as the similar contents.

16. The apparatus of claim 11, wherein the representative labeling unit selects the representative sentences by determining whether a length of the classified sentences and preset representative words are included.

17. The apparatus of claim 11, wherein the weight calculator sets the number of sentences as a weight reference and assigns preset higher weights to the advantages posted exceeding the reference of weight and assigns preset lower weights to the advantages posted below the reference of the weight.

18. The apparatus of claim 11, further comprising: an analysis result modeling unit performing and outputting modeling of analysis information based on the extracted sentences, the selected representative sentences, and calculated weight information.
